(19) United States
(12) Patent Application Publication
(10) Pub. No.: US 2025/0315691 A1
(43) Pub. Date: Oct. 9, 2025

(54) CONTEXT-AWARE PROMPT MATCHING SYSTEM USING LARGE LANGUAGE MODELS

(71) Applicant: Oracle International Corporation, Redwood Shores, CA (US)

(72) Inventors: Iman Zadeh, Los Angeles, CA (US); Jun Qian, Bellevue, WA (US)

(21) Appl. No.: 18/627,340

(22) Filed: Apr. 4, 2024

(51) Int. Cl. G06N 5/01

(52) U.S. Cl. CPC G06N 5/01

(57) ABSTRACT

Techniques for a context-aware prompt matching system using large language models (LLMs) are provided. In one technique, a first LLM receives input that comprises a prompt for a second LLM and accesses a set of prompts. Based on the set of prompts and the prompt, the first LLM identifies a subset of the set of prompts. A particular embedding is generated based on the prompt. For each embedding in a set of embeddings, each of which corresponds to a different prompt in the subset, a similarity score is generated between that embedding and the particular embedding. The set of embeddings are ranked based on the generated similarity scores. A highest ranked embedding, in the set of embeddings, that corresponds to a particular prompt in the subset is identified. The particular prompt may be automatically input to the second LLM or may be presented to a user for selection.

### FIELD OF THE INVENTION

The present disclosure relates to large language models (LLMs). More particularly, the present disclosure relates to improving prompts provided to LLMs by introducing a context-aware functionality to LLM prompts.

### BACKGROUND

Use of large language models (LLMs) has grown exponentially as these LLMs have been applied to an increasingly diverse range of applications. As a result, many efforts have been made to improve the ease of use of LLMs as well as improvements to the outputs generated by the LLMs. In general, these improvements have been made through improvement (or creation) of foundational models and/or use of advanced training techniques or fine tuning. However, these are laborious tasks that require many iterations and are error prone.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of an example an architecture for providing prompt matching functionality;

FIG. 2 is a flow diagram of an example approach to identifying stored prompts based on an input prompt, in an embodiment;

FIG. 3 a block diagram that illustrates a computer system upon which an embodiment of the invention may be implemented; and

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details.

In other instances, well-known structures and devices are shown in block diagram form in order to avoid unnecessarily obscuring the present invention.

### General Overview

While improvement (or creation) of foundational models and/or use of advanced training techniques or fine tuning can provide a certain level of improvement, issues may still exist with respect to formulating effective prompts to elicit the desired outputs from the LLMs. As described in greater detail below, one issue to be addressed pertains to the identification of optimal pre-built prompts within a repository for applications. One potential solution is to employ indexing and search methodologies. However, a significant challenge in this approach lies in the efficient retrieval of relevant information when the search context is vague or inadequately defined. Conventional indexing techniques struggle to provide accurate results in scenarios where the search query lacks precise contextual information, leading to inefficiencies that can result in information overload. Consequently, there is a desire for the development of improved, context-aware techniques that can navigate these challenges effectively. Such advancements are essential to streamline the process of finding suitable prompts for specific tasks for use with LLMs to enhance their usability and performance across various applications.

As described in greater detail below, various approaches using Large Language Models (LLMs) are provided that not only identify the context of the text that users seek but also to align pre-designed prompts with that context. In an example, a dataset of engineered prompts is accessed using an LLM to understand the prompt context. In an example, this context creation process is not repeated unless new entities or concepts are introduced into the prompt repository. In an example, text embedding and semantic search are used to find the closest distance between the user input text and stored prompts and provide the user with the top prompt(s) that is/are semantically closest to the user's input.

By determining the closest match between the user input and prompts in a prompt bank, highly relevant prompts can be efficiently provided to the user, which can increase the functionality and/or efficiency of the host system. Further, the user experience may be greatly improved, and more accurate results can be delivered in a shorter time frame.

The various approaches described differ from conventional prompt search methods by dramatically streamlining the prompt search process. This, in turn, presents numerous advantages, especially when dealing with a vast number of pre-designed prompts. Notably, the described approaches not only save time but also reduce costs significantly. By narrowing down the search space and pinpointing the most relevant prompts, users can avoid the need for excessive application program interface (API) calls to the LLM to try different prompts. This efficiency ensures that the system operates more economically, as it minimizes the computational resources required for each query while expediting the retrieval of the most suitable prompts. LARGE LANGUAGE MODEL OVERVIEW

A large language model (LLM) is a type of artificial language (AI) model that is trained on a dataset of text (e.g., books, articles, websites, social media posts) to learn statistical relationships between words, phrases, etc. This allows the LLM to generate text similar to the text used for training. LLMs are commonly trained using neural networks that are well-suited for natural language processing because they can learn long-range dependencies between words and understand nuances of language processing.

Training of LLMs generally involves various stages and components including, for example, embeddings, tokenization, attention, pre-training and/or transfer learning. Embeddings are generally vector representations of words or tokens corresponding to semantic meanings in a high-dimensional space. Embeddings allow the LLM to convert the words or tokens to be converted to a format that can be processed by a neural network. LLMs can learn embeddings during training to capture relationships between words or tokens (e.g., synonyms, analogies).

Tokenization is the process of converting a sequence of text into individual words, word fragments or tokens that the LLM can understand. Various attention mechanisms allow the LLM to evaluate the importance of different words and phrases.

Pre-training of the LLM is the process of training the LLM on a large dataset (e.g., unsupervised or self-supervised) before fine tuning the LLM for a specific task. During pre-training, the LLM learns general language patterns, relationships between words and other foundational concepts. The pre-training process creates a model that can be fine-tuned for one or more specific tasks using smaller datasets.

Transfer learning is the process of leveraging the knowledge gained during pretraining and applying it to a new, related task. In the context of LLMs, transfer learning can involve fine tuning a pretrained model on a smaller, task-specific dataset to achieve improved performance in that specific task. This allows the model to benefit from general language knowledge learned during pretraining, which reduces the training required for each new task.

As discussed above, embeddings are used to represent words as vectors of numbers, which can be used by the LLM to understand the meaning of the corresponding text. Various types of embeddings can be used. “One-hot” encoding is an approach where each word is represented as a vector of zeros with a single one at the index corresponding to the word's position in the vocabulary. For example, in a vocabulary of 10,000 words the word “house” can be represented as a vector of 9,999 zeros with a “1” at an index corresponding to “house” (e.g., Index 0). One-hot encoding is a simple and efficient approach but does not provide context for the words. For example, a word can have two meanings, but it would be represented by the same vector. This can hinder machine learning models.

More complex embedding techniques can be utilized, a short listing of which follows: Term Frequency-Inverse Document Frequency (TF-IDF) provides a statistical measure of the importance of a word; N-grams are sequences of N words and can capture semantic meaning of words; ELMo incorporates both word-level characteristics and contextual semantics; Bi-Directional Language Models (bi-LSTM) captures the meaning of a word, the context and its inherent properties. Further examples include GloVe and Word2Vec. Other embedding approaches can also be supported.

### System Overview

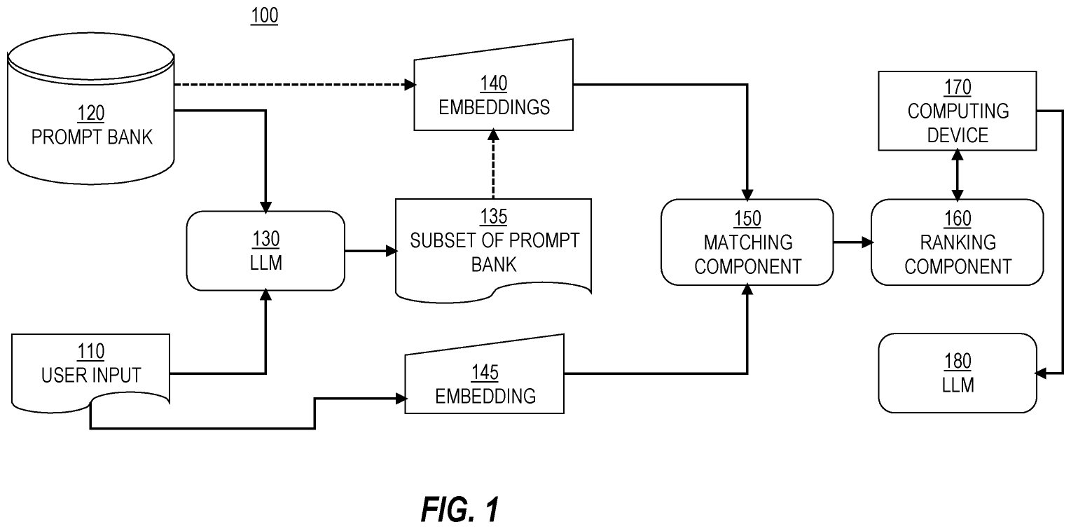

FIG. 1 is a block diagram of an example system 100 for providing prompt matching functionality, in an embodiment. In example system 100, a user (operating a computing device, not depicted) provides user input 110. User input 110 is provided via some sort of user interface (UI), which is not explicitly illustrated in FIG. 1. In an example, the Ul can be a graphical user interface (GUI) through which the user provides user input 110 by typing and/or selecting inputs via cursor or other mechanisms. As another example, the Ul can be an audio interface through which the user provides user input 110 via spoken word and/or other audio mechanisms. As a further example, the Ul can be a video interface through which the user provides user input 110 via gestures and/or other visible mechanisms.

In an example, user input 110 includes at least one prompt that is to be used with a target LLM (e.g., LLM 180); however, user input 110 can include multiple prompts to be used with the target LLM. In an example, prompt bank 120 includes a repository of prompts that have been designed/selected to work with the target LLM. Prompt bank 120 may include tens or hundreds of prompts.

In an example, LLM 130 accepts, as input, user input 110 along with one or more prompts from prompt bank 120 and identifies a subset 135 of prompts from prompt bank 120. User input 110 may be a modified version of an original prompt from the user. For example, user input 110 may be modified to include an invitation to find similar prompts in prompt bank 120, an example of the invitation being the following: “Find one or more prompts in the prompt bank that are similar to the following prompt.”

Identifying similar prompts involves identifying the context of user input 110 and the context of each prompt in prompt bank 120 (or at least multiple prompts in prompt bank). For example, LLM 130 is trained to identify keywords, key names, key themes, topics, etc. Therefore, the identified content in user input 110 is matched to identified context from a prompt in prompt bank 120 in order to determine a sufficiency of a match between the two; and if so, then that prompt is added to subset 135. Such an online extraction of contexts from prompts in prompt bank 120 may be preferable if prompt bank 120 is dynamic and continuously evolving. In contrast, offline extraction (where contexts of prompts in prompt bank 120 are extracted prior to receiving user input 110) may be preferrable for static or less dynamic prompt banks.

In an embodiment, prompt bank 120 comprises multiple sets of prompts that are organized based on type, use, category of subject matter, and/or another factor. For example, one set of prompts in prompt bank 120 may be prompts regarding healthcare whereas another set of prompts in prompt bank 120 may be prompts regarding engineering. Thus, user input or metadata associated with user input may indicate a particular type, use, or category. With this information, LLM 130 may limit which prompts are accessed or considered when identifying similar prompts from prompt bank 120.

In an embodiment, prompt bank 120 is associated with multiple levels. For example, in the health domain, LLM 130 may initially ascertain the specific application, such as medical health record summarization. Subsequently, LLM 130 may delve into finer details, progressing from medical imaging report to imaging modality (e.g., PET/MRI/CT-SCAN), and finally focusing on the specific body part (e.g., abdomen/skull/brain).

In the example of FIG. 1, embeddings 140 are generated for the prompts in subset 135 and an embedding 145 is generated for user input 110. The embeddings are generated by an embedding generator (not depicted) that accepts prompt text as input and generates embeddings therefrom. Embedding 145 is generated after system 100 receives user input 110. On the other hand, embeddings 140 may be generated either in response to receiving user input 110 or prior to receiving user input 110. In this latter scenario, embeddings 140 may be stored in prompt bank 120 in association with the corresponding prompts from which those embeddings were generated. Thus, no time or computer resources are required to generate embeddings 140 on-the-fly, which avoidance will speed up the process for identifying one or more candidate prompts for the user. Instead, once a prompt is identified in subset 135, a row identifier (or other object identifier) may be used to identify, in prompt bank 120, the embedding that is associated with the identified prompt.

Matching component 150 matches or compares embedding 145 to each embedding of embeddings 140, a result of which is a score for each pair of embeddings. Such comparing may involve a cosine similarity operation, which outputs a score between 0 and 1, 1 representing a perfect match between two embeddings.

Ranking component 160 ranks (or orders) prompts in subset 135 based on their respective scores generated by matching component 150. Ranking component 160 may cause all ranked prompts to be displayed or a strict subset of the ranked prompts to be displayed. For example, ranking component 160 may only cause the top N prompts to be displayed, regardless of whether the number of prompts in subset 135 is greater than N. N may be any positive integer greater than 0, such as five.

After being displayed on a computing device 170, a user (e.g., that provided user input 110) may then select one or more prompts from the ranked prompts. A selected prompt is transmitted to LLM 180, which may be the same as or different than LLM 130.

If the user selects multiple prompts, then each selected prompt may be sent to LLM 180 in sequence or in parallel if there are multiple instances or copies of LLM 180. If in sequence, then the selected prompts may be ordered by their respective scores or based on an order in which the user selected the prompts. For example, if there are five displayed prompts and the user selected the second ranked prompt first and selected the fifth ranked prompt second, then the first selected prompt is transmitted to LLM 180 first. If the user provides input that indicates that s/he is satisfied with the result generated by LLM 180 based on the first selected prompt, then no more prompts are transmitted to LLM 180. On the other hand, if the user provides input that indicates that s/he is not satisfied with that result, then the second selected prompt is transmitted to LLM 180; and so forth.

### Technical Improvements and Benefits

The architecture described in FIG. 1 can provide an efficient and improved approach to identifying optimal prompts within a pre-defined prompt repository (e.g., prompt bank 120) guided by user input 110 and/or a specific application/task. This approach is adaptable to both pre-trained and fine-tuned LLMs and provides improved efficiency in streamlining the prompt search process, particularly when dealing with a substantial inventory of pre-designed prompts. This efficiency translates into significant time and cost savings.

By narrowing down the search scope and pinpointing the most relevant prompts, the approaches described herein can obviate the need for extensive API calls to the LLM model to experiment with different prompts. Consequently, these approaches not only enhance computational resource efficiency but also expedite the retrieval of the most suitable prompts. That is, the described approaches represent compelling and cost-effective solutions for identifying highly relevant prompts within databases (e.g., prompt bank 120), thereby elevating the user experience and overall efficiency of prompt-based interactions with LLMs.

As described in greater detail below, the approaches described herein provide improvements in functionality and performance of prompt-based interactions with LLMs. One potential advantage is enhanced prompt retrieval. The approaches described herein provide a more efficient and context-aware approach to prompt retrieval within a database of pre-defined prompts (e.g., prompt bank 120). This functionality significantly improves the user experience by ensuring that users can quickly access the most relevant prompts for their specific needs. This, in turn, enhances the efficiency of utilizing LLMs for various tasks.

Another potential advantage is time and cost savings. By streamlining the prompt search process and eliminating the need for extensive trial-and-error API calls to LLMs, the approaches described can save valuable time and computational resources. This leads to cost savings for businesses by reducing the overhead associated with prompt discovery and experimentation. The reduction in computational resources also makes the system more environmentally friendly.

A further potential advantage is improved user productivity. Users can find optimal prompts with greater ease and speed, allowing them to focus on their core tasks rather than getting bogged down in the prompt design process. This improved productivity can translate into higher output and better outcomes for businesses and individual users.

Another potential advantage is enhanced adaptability. The approaches described are adaptable to both pre-trained and fine-tuned LLM models, providing versatility in its application. This adaptability means that businesses can leverage their existing LLM investments more effectively, extending the utility of these models across various use cases without the need for substantial retraining or model adjustments.

A further potential advantage is providing a competitive advantage. Entities that utilize the described advantages gain a competitive edge by streamlining their prompt-based interactions with LLMs. These entities can respond more rapidly to changing market demands, offer more tailored services, and provide more accurate information, all of which can attract and retain customers.

Thus, the approaches described significantly add value to various platforms, entities and/or host architectures by improving the functionality, efficiency, and cost-effectiveness of prompt-based interactions with LLMs. This translates into tangible benefits for many entities including businesses, by providing enhanced user experiences, cost savings, increased productivity, and a competitive advantage in the relevant markets.

Additionally, the approaches described provide adaptability across a wide range of use cases, whether there are only a few prompts or a substantial number. The ability to effectively function and grow remains a critical advantage, particularly when users modify or introduce their own prompts to the prompt repository.

### Stored Prompt Identification Process

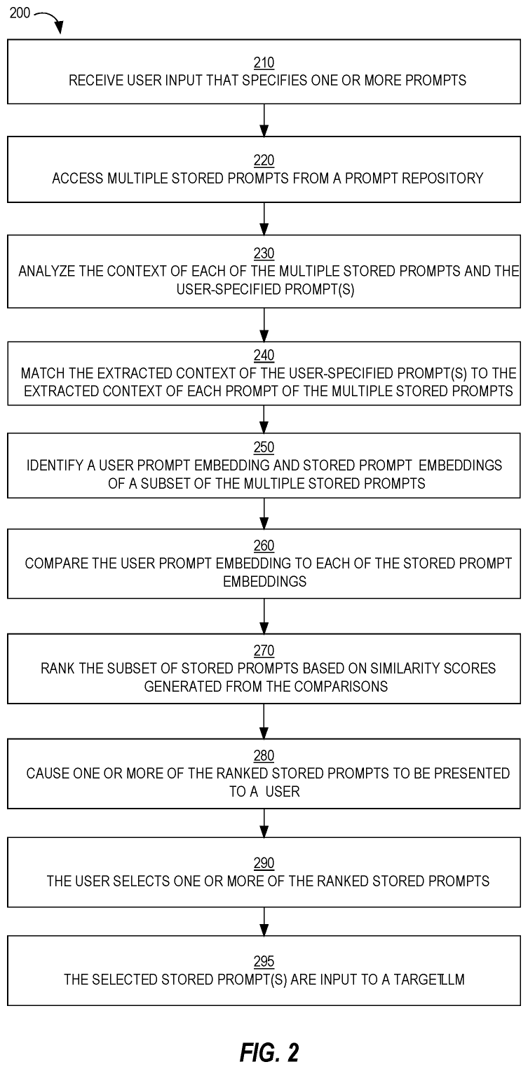

FIG. 2 is a flow diagram of an example process 200 for identifying stored prompts that are most similar to a user-specified prompt, in an embodiment. Process 200 may be performed by different components or elements of FIG. 1, such as LLM 130 and matching component 150, and even components not depicted in FIG. 1.

At block 210, input is received. In an example, the input is received via a user interface (UI), such as a graphical user interface (GUI) through which a user provides one or more prompts by typing and/or selecting inputs via a cursor, menu selection, dialog box, etc. In an example, the Ul can include an audio interface through which a user provides input via spoken word and/or other audio mechanisms. The Ul can further include a video interface through which a user provides input via gestures and/or other visible mechanisms. Block 210 may involve automatically modifying (e.g., by a component that is associated with the LLM) the user input to include an auto-generated prompt for the LLM, such as “Find the top 5 prompts in the prompt bank to the following user-specified prompt.”

At block 220, multiple stored prompts are accessed from at least one prompt repository (e.g., prompt bank 120 in FIG. 1). Accessing the stored prompts may occur in response to receiving the input at block 210. The accessed stored prompts may be all prompts that are stored in the prompt repository. Alternatively, the accessed stored prompts may be a strict subset of all the prompts that are stored in the prompt repository.

At block 230, the context of each stored prompt and the input prompt is analyzed. For example, the LLM processes each stored prompt and the prompt(s) in the (e.g., user) input through a deep neural network architecture, capturing the nuanced semantics, relationships between words, and overall context.

Contextual analysis involves finding meaningful insights from the LLM input including, for example, key themes and entities (e.g., identify central themes, topics and/or subjects in the text, which can involve entity recognition to spot named entities like people, places, organization, etc.), topic classification (e.g., categorization of the text into broader topics, domains or fine grained topics, for example, finance, health care, entertainment, resume writing, job posting, etc.), and key word identification by extracting key words or phrases that encapsulate the essence of the text, etc.

At block 240, once the context of the stored prompts and the context of the input (e.g., user-specified) prompt have been analyzed, the extracted context of the input prompt is matched to the extracted context of each stored prompt. Example matching techniques include keyword matching, semantic similarity, and contextual embeddings. Regarding the keyword matching technique, keywords or phrases in the context of the input prompt are compared to keywords or phrases in the context of the stored prompts. Stored prompts with the highest keyword overlap are considered more relevant.

Another matching technique is semantic similarity, which involves use of natural language processing techniques (e.g., Word2Vec, GloVe) and/or transformer-based models (e.g., BERT, Cohere Text Embedding) to gauge the semantic similarity between the user context and the context of the stored prompts, where stored prompts associated with higher semantic similarity scores are prioritized.

Another matching technique involves contextual embeddings, which are generated by transformer models (e.g., BERT, ROBERTa, Cohere) to capture the nuanced meaning and context of a set of text. These example embeddings capture the semantic and contextual information of words, phrases, or entire documents, representing them as dense numerical vectors in a high-dimensional space. This transformation allows for the encoding of relationships between words and phrases based on their positions in this vector space, making it possible to perform tasks like sentiment analysis, document classification, and information retrieval. Similarities between the embedding of the input and embeddings of stored prompts are computed. Such embeddings may be different than the embeddings that are used to rank the top N stored prompts. While the different embeddings may potentially match, stored prompts typically comprise fewer tokens or words, necessitating smaller transformers. In contrast, for user inputs, a larger model size may be required to accommodate a greater number of tokens.

Output of block 240 may comprise prompt identification data that identifies the top N stored prompts that match the prompt(s) in the input. The prompt identification data may comprise location identifiers that identify a logical or actual location in storage, such as persistent storage. An example of a location identifier is a row identifier that identifies a specific row in a particular table in a database.

At block 250, an input prompt embedding and stored prompt embeddings are identified. An input prompt embedding may be generated by an embedding generator. The stored prompt embeddings correspond to the top N stored prompts that the LLM identified based on the input. The stored prompt embeddings may have been generated by the same embedding generator. The stored prompt embeddings may have been generated prior to block 210, i.e., before receiving the input. Thus, each stored prompt in the prompt repository may be associated with an embedding that was generated by the embedding generator before the input was received in block 210. The input prompt embedding may have been generated any time after block 210 and before block 260. The stored prompt embeddings may be stored in the same data structure as the stored prompts from which they were generated. For example, a stored prompt and its corresponding embedding may be stored in the same row of a particular table in a database.

At block 260, a comparison is performed on the embeddings, namely between the input prompt embedding(s) generated for the one or more input prompts in the input and each stored prompt embedding of the stored prompt embeddings identified in block 250. Each comparison results in a similarity score. Example comparisons include cosine similarity, Manhattan distance, Euclidean distance, and Minkowski distance.

At block 270, the stored prompts are ranked based on the similarity scores generated in block 260. For example, the stored prompt that is associated with the highest similarity score is ranked first, the stored prompt that is associated with the second highest similarity score is ranked second, and so forth.

At block 280, one or more of the ranked stored prompts are presented to a user, such as via a UI. For example, only the top ranked stored prompt (or the ranked stored prompt with the highest similarity score) is presented to the user. Alternatively, multiple of the ranked stored prompts are presented to the user. Such a presentation may be in the form of an ordered list, a drop-down list, autofill, etc. The multiple ranked stored prompts may be presented with visual data that indicates which ranked stored prompt has the highest similarity score. For example, the data may be a numeral (e.g., “1”), a color, an icon, or the placement of the ranked stored prompt in a user interface relative to the placement of other ranked stored prompts, such as top-down or left-to-right.

Block 280 may involve comparing one or more similarity scores with a threshold similarity score. If the similarity score is less than the threshold similarity score, then the corresponding stored prompt is not presented to the user; otherwise, the corresponding stored prompt is presented to the user. For example, if no similarity score from a set of ranked stored prompts is greater than the threshold similarity score, then either no ranked stored prompt is presented to the user or only the top ranked stored prompt is presented to the user.

At block 290, the user, via the UI, selects one or more of the ranked stored prompts that are presented. Selection may be the user using his/her finger to touch a portion of a touchscreen (of a computing device that the user is operating) that corresponds to where the one or more ranked stored prompts are presented. Alternatively, selection may be selection of one or more buttons on a physical keyboard that is associated with the computing device. Alternatively, selection may be using a cursor control device (e.g., mouse) to move a visual cursor or the one or more ranked stored prompts. Alternatively, selection may be the user speaking a sentence or saying one or more numbers associated with the one or more ranked stored prompts, where a microphone of the computing device captures the audio input and generates digital audio data, which is analyzed (e.g., by the computing device or an external service) to determine what the user said.

At block 295, the selected prompt(s) are used as input to a target LLM, which may be different than the LLM that performed the contextual analysis. The selected prompt(s) serve as input for generating responses or content that aligns with the context extracted from the initial text input.

In a related embodiment, instead of presenting a ranked stored prompt to a user, the top ranked prompt is automatically selected and input to the target LLM. This embodiment is useful if there is a lot of confidence in the selection and ranking of the stored prompts and/or if the top-ranked stored prompt is usually selected. For example, if a set of one or more users tend to select the top-ranked stored prompt 95% of the time, then presenting the top-ranked stored prompt prior to inputting that prompt to the target LLM may be skipped. Such a selection rate may be computed based on the selections of multiple users, or may be specific to the user in question, or may be specific to a group of users that are similar to the user. If the selection rate is greater than a certain threshold (e.g., 85%), then the top-ranked stored prompt may be selected and input to the target LLM automatically.

In an example, the selected prompt(s) are used as input to the target LLM to obtain responses, answers, or content that closely matches the context. The target LLM generates content based on the provided prompts, ensuring relevance and context-awareness.

In an example, the host system gathers (continuously or periodically) user feedback to monitor the performance of the context extraction and matching system. The process can be fine-tuned by adapting the matching techniques, prompt database, or context extraction techniques based on user preferences and evolving contexts.

In an example, host system performance is assessed in context matching to ensure that it consistently delivers relevant and accurate prompts. Adjustments can be made to enhance the effectiveness of the matching process.

By focusing on context extraction and employing appropriate matching techniques, the system efficiently connects the context of a text with the most appropriate prompts, enabling context-aware interactions with the LLM.

The approaches described above can expand the utility of the AI domain and a diverse array of downstream use cases and services seeking to harness the capabilities of AI. This groundbreaking innovation holds the potential to be packaged and offered to customers as a dependable and expedited tool for identifying the most pertinent pre-designed prompts. This approach not only maximizes efficiency in terms of time but also minimizes costs associated with unnecessary API calls to LLMs during prompt exploration, particularly when dealing with a substantial reservoir of pre-designed prompts.

The approaches described above also contribute to enhancing the scalability of services including, for example, cloud-based solutions. The flexibility of this approach allows it to adapt to scenarios involving varying numbers of prompts across diverse use cases. This adaptability proves valuable as user preferences evolve or prompt exploration becomes more extensive over time. Such adaptability aligns harmoniously with the scalable and versatile nature of cloud infrastructures.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

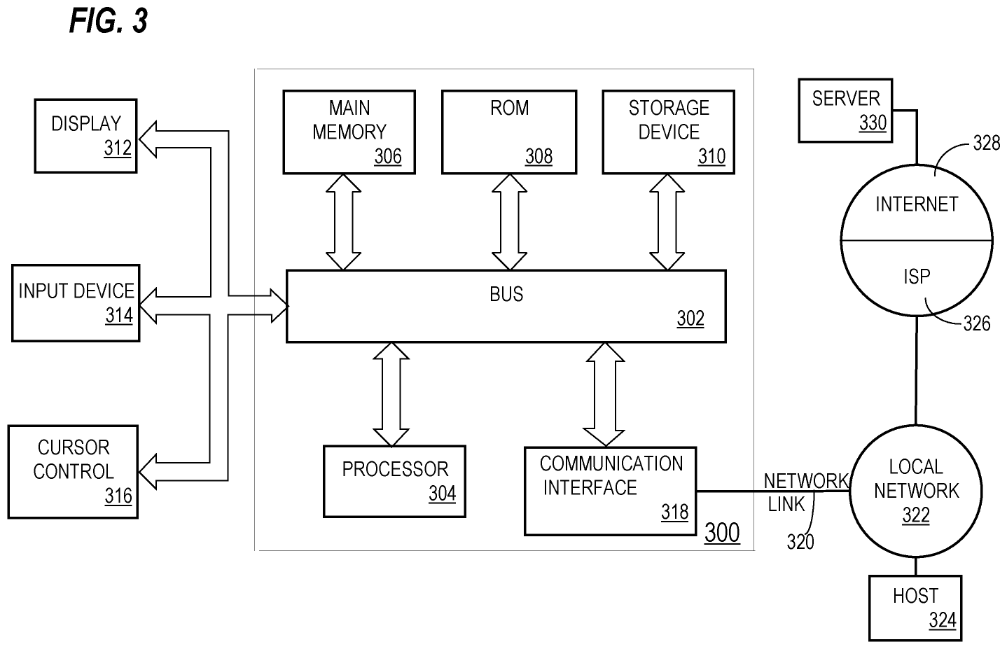

For example, FIG. 3 is a block diagram that illustrates computer system 300 upon which various embodiments may be implemented. Computer system 300 includes bus 302 or other communication mechanism for communicating information, and hardware processor 304 coupled with bus 302 for processing information. Hardware processor 304 may be, for example, a general-purpose microprocessor.

Computer system 300 also includes a main memory 306, such as a random-access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304 including, for example, instructions to execute the functionality described with respect to FIG. 1 and/or FIG. 2. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to network link 320 that is connected to local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to host computer 324 or to data equipment operated by Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

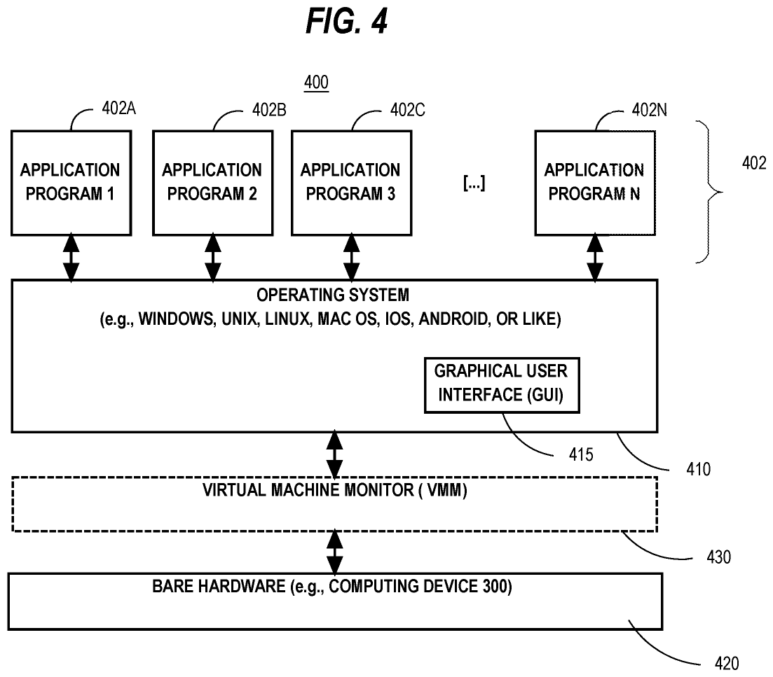

FIG. 4 is a block diagram of basic software system 400 that may be employed for controlling the operation of computing system 400. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 400. Software system 400, which may be stored in system memory (RAM) 406 and on fixed storage (e.g., hard disk or flash memory) 410, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 410 into memory 406) for execution by the system 400. The applications or other software intended for use on computer system 400 may also be stored as a set of downloadable computer-executable instructions, for example, for downloading and installation from an Internet location (e.g., a Web server, an app store, or other online service).

Software system 400 includes graphical user interface (GUI) 415, for receiving user commands and data in a graphical (e.g., “point-and-click” or “touch gesture”) fashion. These inputs, in turn, may be acted upon by system 400 in accordance with instructions from operating system 410 and/or application(s) 402. GUI 415 also serves to display the results of operation from OS 410 and application(s) 402, whereupon the user may supply additional inputs or terminate the session (e.g., log off).

OS 410 can execute directly on the bare hardware 420 (e.g., processor(s) 404) of computer system 400. Alternatively, a hypervisor or virtual machine monitor (VMM) 430 may be interposed between the bare hardware 420 and OS 410. In this configuration, VMM 430 acts as a software “cushion” or virtualization layer between OS 410 and bare hardware 420 of computer system 400.

VMM 430 instantiates and runs one or more virtual machine instances (“guest machines”). Each guest machine comprises a “guest” operating system, such as OS 410, and one or more applications, such as application(s) 402, designed to execute on the guest operating system. VMM 430 presents the guest operating systems with a virtual operating platform and manages the execution of the guest operating systems.

In some instances, VMM 430 may allow a guest operating system to run as if it is running on bare hardware 420 of computer system 400 directly. In these instances, the same version of the guest operating system configured to execute on bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an laaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, by a first large language model (LLM), input that comprises a prompt for a second LLM;
accessing, by the first LLM, a set of prompts;
based on the set of prompts and the prompt, identifying, by the first LLM, a subset of the set of prompts;
generating a particular embedding based on the prompt;
for each embedding in a set of embeddings, each of which corresponds to a different prompt in the subset of the set of prompts:
generating a similarity score between said each embedding and the particular embedding;
associating the similarity score with said each embedding;
adding the similarity score to a set of similarity scores;
ranking the set of embeddings based on the set of similarity scores;
identifying at least one highest ranked embedding, in the set of embeddings, that corresponds to a particular prompt in the subset;
wherein the method is performed by one or more computing devices.

2. The method of claim 1, wherein accessing, by the first LLM, a set of prompts comprises accessing a repository of stored prompts.

3. The method of claim 2, wherein identifying, by the first LLM, a subset of the set of prompts comprises performing keyword matching or performing semantic similarity analysis.

4. The method of claim 1, wherein the first LLM has been pre-trained to perform contextual analysis.

5. The method of claim 1, further comprising:
causing the particular prompt to be presented on a screen of a computing device;
receiving user selection of the particular prompt; and
in response to receiving the user selection, inputting the particular prompt to the second LLM.

6. The method of claim 5, further comprising:
causing the second LLM to operate on the particular prompt to generate an output; and
causing the output to be presented on the screen of the computing device.

7. The method of claim 1, wherein the second LLM is different than the first LLM.

8. The method of claim 1, wherein causing the particular prompt to be presented comprises causing multiple prompts to be presented on the screen of the computing device.

9. The method of claim 8, wherein causing the multiple prompts to be presented comprises causing the multiple prompts to be presented based on their corresponding similarity scores.

10. The method of claim 1, wherein identifying the subset comprises identifying a pre-determined number of prompts from the set of prompts.

11. The method of claim 1, wherein the set of prompts comprises a plurality of categories of prompts, each category of the plurality of categories comprising multiple pre-defined prompts of a type belonging to said each category.

12. One or more non-transitory storage media storing instructions which, when executed by one or more computing devices, cause:
receiving, by a first large language model (LLM), input that comprises a prompt for a second LLM;
accessing, by the first LLM, a set of prompts;
based on the set of prompts and the prompt, identifying, by the first LLM, a subset of the set of prompts;
generating a particular embedding based on the prompt;
for each embedding in a set of embeddings, each of which corresponds to a different prompt in the subset of the set of prompts:
generating a similarity score between said each embedding and the particular embedding;
associating the similarity score with said each embedding;
adding the similarity score to a set of similarity scores;
ranking the set of embeddings based on the set of similarity scores;
identifying at least one highest ranked embedding, in the set of embeddings, that corresponds to a particular prompt in the subset.

13. The one or more storage media of claim 12, wherein identifying, by the first LLM, a subset of the set of prompts comprises performing keyword matching or performing semantic similarity analysis.

14. The one or more storage media of claim 12, wherein the first LLM has been pre-trained to perform contextual analysis.

15. The one or more storage media of claim 12, wherein the instructions, when executed by the one or more computing devices, further cause:
causing the particular prompt to be presented on a screen of a computing device;
receiving user selection of the particular prompt; and
in response to receiving the user selection, inputting the particular prompt to the second LLM.

16. The one or more storage media of claim 15, wherein the instructions, when executed by the one or more computing devices, further cause:
causing the second LLM to operate on the particular prompt to generate an output; and
causing the output to be presented on the screen of the computing device.

17. The one or more storage media of claim 12, wherein the second LLM is different than the first LLM.

18. The one or more storage media of claim 12, wherein causing the particular prompt to be presented comprises causing multiple prompts to be presented on the screen of the computing device.

19. The one or more storage media of claim 18, wherein causing the multiple prompts to be presented comprises causing the multiple prompts to be presented based on their corresponding similarity scores.

20. The one or more storage media of claim 12, wherein the set of prompts comprises a plurality of categories of prompts, each category of the plurality of categories comprising multiple pre-defined prompts of a type belonging to said each category.
